(19) United States
(12) Patent Application Publication
(10) Pub. No.: US 2005/0103591 A1
(43) Pub. Date: May 19, 2005

(54) Electric supply rail with collecting carriage

(76) Inventors: Laurent Micheau, Fleurieu Sur Saone (FR); Bernard Thelier, Bellerive Sur Allier (FR)

Correspondence Address: OLIFF & BERRIDGE, PLC, P.O. BOX 19928, ALEXANDRIA, VA, 22320, US

(21) Appl. No.: 10/489,163

(22) PCT Filed: Sep. 11, 2001
(86) PCT No.: PCT/FR01/02824

(51) Int. Cl. B60M 1/34

(52) U.S. Cl. 191/23 R

(57) ABSTRACT

The invention concerns a power supply rail (1) in the form of a profiled section (3), wherein are longitudinally arranged electrically conductive tracks (4), which co-operate with current collector shoes (11) borne by the collector carriage (2), guided by the rail (1), said carriage being connected to a mobile element to be electrically powered. Inside the rail (1) is provided a continuous position and/or displacement detecting track (17), which co-operates with a detector (18) borne by the part (7) of the collector carriage (2) housed inside the rail (1). The detector is linked to signal processing means (23). The instantaneous position and/or the displacement of the associated mobile element can thus be controlled.

The present invention relates to an electric supply rail, shaped as a profiled section and inside which there are longitudinally arranged electrically conducting tracks, this rail guiding a current-collecting carriage connected to a moving element that is to be electrically powered, this carriage being provided with current-collecting wipers, coming into contact with the conducting tracks of the rail, and means being provided for monitoring the position of the moving element.

In certain industries it is necessary to be able to electrically power elements, assemblies or moving apparatus, for example electrically operated tools, that are to be used at a variable location within a certain space. To do this, one known technical solution is to use an electric supply rail with a collecting carriage.

The supply rail, usually arranged horizontally, consists of a profiled section made of electrically Insulating material, closed on all sides except for a longitudinal slot made in its bottom face. Arranged inside the profiled section are electrically conducting tracks, particularly ones made of copper, in varying number, these conducting tracks being distributed over the internal side walls and/or the upper wall of the profiled section.

The current-collecting carriage comprises an upper part housed inside the rail, and a lower part situated under the rail, these two parts being connected by an intermediate part which passes through the longitudinal slot in the profiled section. The part of the carriage that is housed inside the rail may or may not be provided with rollers which roll along guide tracks formed inside the profiled section. This part of the carriage also carries current-collecting wipers in sliding contact with the conducting tracks of the rail. The part of the collecting carriage situated under the rail serves as an outlet for an electrical power supply lead leading toward the mobile element that is to be powered, which “follows” the carriage in its movements.

Hence, regardless of its position, the collecting carriage collects electrical current and conveys the current to the associated moving element. The rail may have straight and/or curved portions and may possibly form a closed loop, it being possible for current to be collected from any point along the rail.

In some applications, the mobile element to be electrically powered by the above-described device is suspended from another carriage that can run along a runway track parallel to the electric supply rail. The position and/or the displacement of the moving element that is to be powered then correspond to the position and/or to the displacement of the current-collecting carriage.

In the latter case, there is a need to determine, at every moment, the position occupied by the moving element, whether this be for safety reasons or in order to control certain actions of this moving element in particular positions. This currently entails the addition of special position-monitoring equipment for monitoring the position of said moving element.

It will also be noted that the customary devices used to monitor the position and/or the displacement of moving bodies guided along rails, particularly suspended carriages moving along rails that also provide an electrical power supply are:
either devices that can be applied only to motorized carriages (see, for example, document GB 2 277 069);
or devices which detect only the passage of carriages through certain particular points (see, for example, documents U.S. Pat. No. 4,700,024 and JP 60154923);
or devices which detect only the presence of the carriages within areas of greater or lesser extent, particularly to avoid collisions between carriages (see, for example, document U.S. Pat. No. 4,688,487).

Thus, the prior art does not propose any simple solution for the “continuous” detection of the precise position of an unmotorized carriage, particularly of a current-collecting carriage connected to another moving element.

The present invention aims to provide a simpler and more economical solution making it possible continuously to detect the position and/or the displacement of the moving element, associated with the current-collecting carriage, with a view to transmitting the position and/or displacement information to any command-control device.

To this end, the object of the invention is essentially an electric supply rail with a collecting carriage, of the kind concerned here, in which, in order to determine the instantaneous position occupied by the moving element there is provided, inside the profiled section that forms the supply rail, a position and/or displacement detection track running continuously along the length of the rail and collaborating with a detector borne by part of the collecting carriage which part is housed inside said rail, the detector being connected to signal processing means for processing the signals originating from this detector.

According to a preferred embodiment of the invention, the position and/or displacement detection track consists of a continuous toothed element toothed with a regular pitch, particularly a toothed belt, fixed longitudinally inside the rail, while the detector, borne by the collecting carriage, is a detector of optical type, for example involving optical fibers, which lies facing the toothed element.

Thus, the invention provides means for detecting the position and/or the displacement of the collecting carriage, and therefore of the moving element associated with this carriage and powered electrically thereby, which are fully incorporated into the supply rail and into the collecting carriage, and which therefore do not require any additional apparatus. These means allow the position to be detected at every point and at every moment. The positions and displacements of the moving element can thus be perfectly monitored.

In addition, in the preferred embodiment of the invention using a toothed belt, use can be had of a means that is particularly economical, but sufficiently precise, this toothed element being of indefinite length and able, where necessary, to follow a curved path. The toothed element, such as a toothed belt, may be housed in an interior longitudinal groove of the profiled section that constitutes the rail, this groove being similar to the other longitudinal grooves belonging to this profiled section, in a usual manner, that accommodates the conducting tracks, thus affording a simple embodiment.

However, in an alternative form of the invention, the position and/or displacement detection track consists of a magnetic stripe or a strip, fixed longitudinally inside the rail and collaborating with a detector of magnetic type.

According to another alternative form, the position and/or displacement detection track consists of a graduated stripe, fixed longitudinally inside the rail and collaborating with a detector of optical type.

According to one advantageous embodiment, the signal processing means for processing the signals originating from the detector borne by the collecting carriage comprise an electronic processing unit borne by the collecting carriage itself. In addition, this “on-board” processing unit may communicate, via the conducting tracks of the rail itself, with a fixed control box which carries out additional information-processing operations, in order to make this information usable, thus avoiding the need to add a wire connection or a radio link.

In practice, the device makes it possible to detect the position of the collecting carriage, recognize its direction of travel, and measure its speed of travel.

The invention will be better understood using the description which follows, with reference to the attached schematic drawing, which, by way of example, depicts one embodiment of this electric supply rail with collecting carriage:

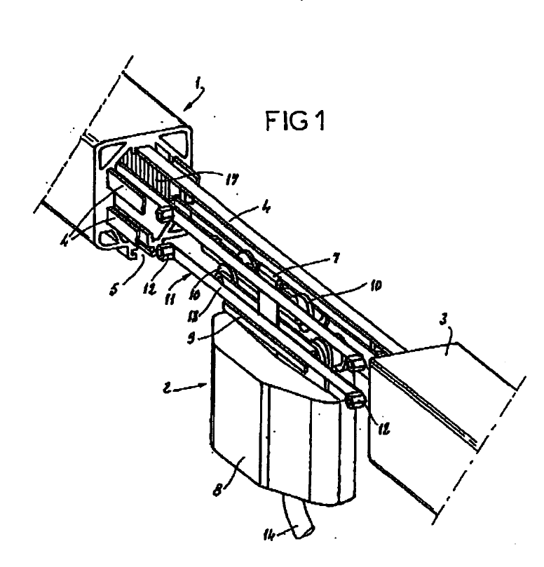

FIG. 1 is an overall perspective view of a supply rail, with partial cutaway, and of the collecting carriage guided by this rail;

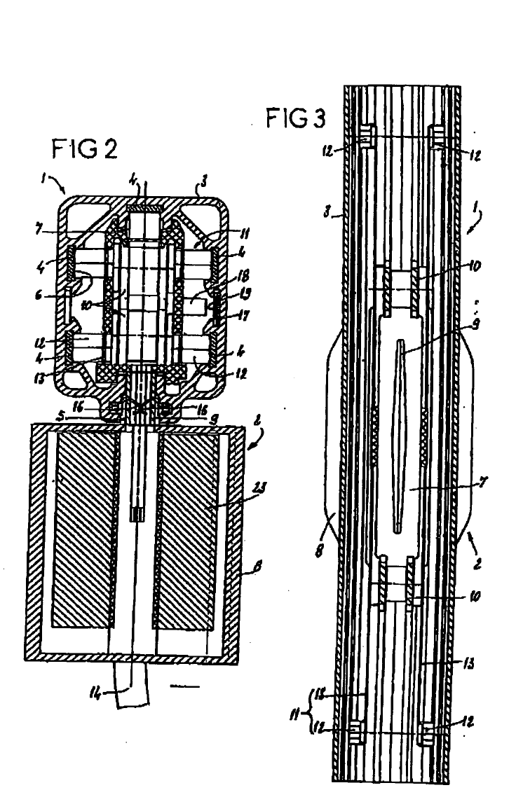

FIG. 2 is a view in cross section of the rail and of the carriage;

FIG. 3 is a view in longitudinal section of the carriage, and of the corresponding region of the rail:

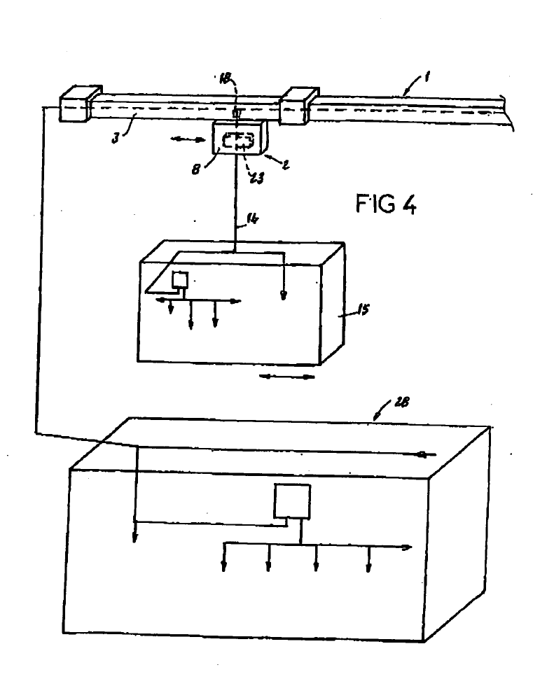

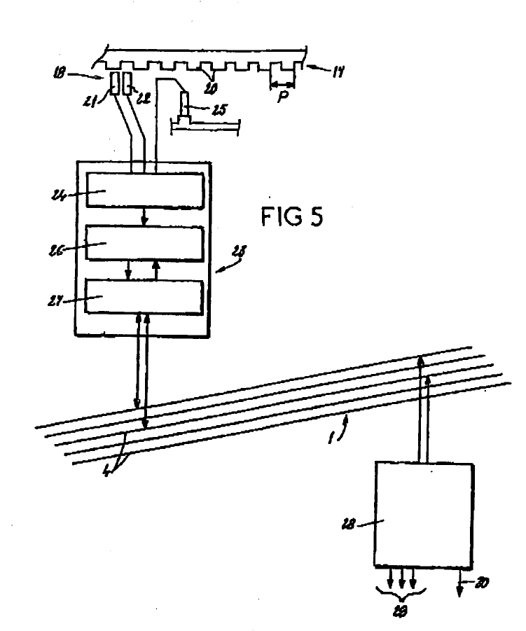

FIG. 4 is a block diagram of the device as a whole, with the associated moving element;

FIG. 5 shows detail of the detector, and the associated electronic board.

In the figures, the reference numeral 1 denotes, in its entirety, an electric supply rail while the reference numeral 2 denotes, overall, a current-collecting carriage guided along the rail 1.

The electric supply rail 1 consists of an insulating profiled section 3, inside which electrically conducting tracks 4 are arranged longitudinally.

The insulating profiled section 3 has a cross section of rectangular shape, with two lateral faces, a top face and a bottom face, as shown in FIGS. 1 and 2. A longitudinal slot 5 is formed in the bottom face of the profiled section 3.

The conducting tracks 4 comprise, in the example illustrated, two superposed conducting tracks 4 placed on one lateral face of the profiled section 3, two other superposed conducting tracks 4 placed on the other lateral face of the profiled section 3, and a last conducting track 4 placed on the top face of the profiled section 3. These five conducting tracks 4 consist in particular of copper strips, housed in internal longitudinal grooves 6 belonging to the profiled section 3.

The electric supply rail 1 is fixed to, and particularly hung from, a support structure, by appropriate means such as hangers, not depicted.

The current-collecting carriage 2 comprises an upper part 7 housed inside the rail 1, and a lower part 8 situated under the rail 1; these two parts 7 and 8 are joined together by an intermediate part 9 which passes vertically through the longitudinal slot 5 in the profiled section 3.

The upper part 7 of the carriage 2 is provided with rollers 10 which roll along guide tracks formed inside the profiled section 3. This upper part 7 also bears current-collecting wipers 11 associated with the various conducting tracks 4 of the rail 1. In the example illustrated, each wiper 11 is made up of two copper wipers 12, mounted at the ends of a metal leaf spring 13 fixed, by its central part, to the body of the upper part 7 of the carriage 2.

The lower part 8 of the carriage 2 is in the form of a box, from which there departs an electrical power supply lead 14 which leads to a moving element, depicted schematically as 15 in FIG. 4, associated with the carriage 2.

In the region of its longitudinal slot 5, the profiled section 3 bears two sealing lips 16, pressing one against each side of the intermediate part 9 of the carriage 2.

There is also provided, within the profiled section 3 that constitutes the electric supply rail 1, a position and/or displacement detection track consisting of a toothed belt 17. The track thus formed collaborates with a detector 18 of optical type, borne by the upper part 7 of the current-collecting carriage 2.

The toothed belt 17, running in the longitudinal direction of the rail 1, is housed and held in an interior longitudinal groove 19 of the profiled section 3. It lies along a side wall of the profiled section 3, between the two conducting tracks 4 borne by the same wall. The notches or teeth 20 of the toothed belt 17 follow on from one another with a constant pitch P, for example of 1.25 mm—see also FIG. 5.

The optical detector 18 is borne by the body of the upper part 7 of the carriage 2, so that it lies facing the toothed belt 17. This is a detector involving optical fibers 21 and 22, which is connected to an “on-board” electronic board 23, this electronic board 23 being housed in the box-shaped lower part 8 of the carriage 2.

The electronic board 23 comprises several functional subassemblies as depicted schematically in FIG. 5:
An optical processing unit 24 provides analog detection of the notches or teeth 20 (rising fronts) of the belt 17. It will be noted that this unit 24 also, via an additional device 25, detects the origin point of a length of rail 1, so as to provide re-zeroing, for example every four meters, so as to avoid any undesirable drift in the detection of the position.
An information processing unit 26 counts, processes and converts the rising fronts and calculates the position, the direction of travel and the speed of travel of the carriage 2.
A last unit 27, acting as a transmitter, electrically matches the signals to allow them to be transmitted in digital form, along the conducting tracks 4 of the rail 1, to a fixed control box 28.

The control box 28, also visible in FIG. 4, which thus receives the information transmitted by the power conductors of the rail 1, performs an additional processing operation on this information to make it usable after processing. In particular, the signals received are processed, within the control box 28, so as to deliver, on an output 29, a signal of the “incremental encoder” type and, on another output 30, speed information in analog form (an electrical voltage proportional to the speed).

The following would not constitute departures from the scope of the invention as defined in the attached claims:
if modifications were made to the shape of the profiled section of which the rail is formed and/or to the number of conducting tracks on this rail;
if the toothed belt were replaced by any similar toothed element such as a rack, or alternatively by a magnetic stripe or strip, or a graduated stripe, collaborating with an appropriate detector;
if the toothed belt or other equivalent detection track were arranged at any position within the rail;
if modifications were made to the configuration of the collecting carriage, which may have a one-piece structure (instead of being made in several parts), it then also being able to be a sliding carriage, with no rollers;
if the signals originating from the detector were processed differently;
if the device were combined with any element, assembly or moving apparatus to be electrically powered, and the position and/or displacement of which were to be monitored.

1. An electric supply rail, shaped as a profiled section and inside which there are longitudinally arranged electrically conducting tracks, this rail guiding a current-collecting carriages connected to a moving element that is to be electrically powered, the position and/or the displacement of which moving element correspond to the position and/or displacement of the current-collecting carriage, this carriage being provided with current-collecting wipers, coming into contact with the conducting tracks of the rail, and means being provided for monitoring the position of the moving element, characterized in that, in order to determine the instantaneous position occupied by the moving element there is provided, inside the profiled section that forms the supply rail, a position and/or displacement detection track running continuously along the length of the rail and collaborating with a detector borne by part of the collecting carriage which part is housed inside said rail, the detector being connected to signal processing means for processing the signals originating from this detector.

2. The electric supply rail with collecting carriage as claimed in claim 1, characterized in that the position and/or displacement detection track consists of a continuous toothed element toothed with a regular pitch; particularly a toothed belt, fixed longitudinally inside the rail, while the detector, borne by the collecting carriage, is a detector of optical type, for example involving optical fibers, which lies facing the toothed element.

3. The electric supply rail with collecting carriage as claimed in claim 2, characterized in that the toothed element, such as a toothed belt, is housed in an interior longitudinal groove of the profiled section that constitutes the rail, this groove being similar to the other longitudinal grooves belonging to this profiled section that accommodate the conducting tracks.

4. The electric supply rail with collecting carriage as claimed in claim 1, characterized in that the position and/or displacement detection track consists of a magnetic stripe or a strip, fixed longitudinally inside the rail and collaborating with a detector of magnetic type.

5. The electric supply rail with collecting carriage as claimed in claim 1, characterized in that the position and/or displacement detection track consists of a graduated stripe, fixed longitudinally inside the rail and collaborating with a detector of optical type.

6. The electric supply rail with collecting carriage as claimed in claim 1, characterized in that the signal processing means for processing the signals originating from the detector borne by the collecting carriage comprise an electronic processing unit borne by the collecting carriage itself.

7. The electric supply rail with collecting carriage as claimed in claim 6, characterized in that the “on-board” processing unit communicates, via the conducting tracks of the rail itself, with a fixed control box which carries out additional information-processing operations.

8. The electric supply rail with collecting carriage as claimed in claim 6, characterized in that the electronic processing unit also, via an additional device, detects the origin point of a portion of the rail so as to perform re-zeroing.

9. The electric supply rail with collecting carriage as claimed in claim 2, characterized in that the signal processing means for processing the signals originating from the detector borne by the collecting carriage comprise an electronic processing unit borne by the collecting carriage itself.

10. The electric supply rail with collecting carriage as claimed in claim 3, characterized in that the signal processing means for processing the signals originating from the detector borne by the collecting carriage comprise an electronic processing unit borne by the collecting carriage itself.

11. The electric supply rail with collecting carriage as claimed in claim 4, characterized in that the signal processing means for processing the signals originating from the detector borne by the collecting carriage comprise an electronic processing unit borne by the collecting carriage itself.

12. The electric supply rail with collecting carriage as claimed in claim 5, characterized in that the signal processing means for processing the signals originating from the detector borne by the collecting carriage comprise an electronic processing unit borne by the collecting carriage itself.

13. The electric supply rail with collecting carriage as claimed in claim 7, characterized in that the electronic processing unit also, via an additional device, detects the origin point of a portion of the rail so as to perform re-zeroing.
